(19) United States
(12) Patent Application Publication
(10) Pub. No.: US 2025/0253371 A1
(43) Pub. Date: Aug. 7, 2025

(54) COOLING SYSTEM

(71) Applicant: ISUZU MOTORS LIMITED, Yokohama-shi (JP)

(72) Inventor: Tomofuyu MATSUUKI, Fujisawa-shi (JP)

(21) Appl. No.: 19/004,526

(22) Filed: Dec. 30, 2024

(30) Foreign Application Priority Data
Feb. 1, 2024 (JP) 2024-014102

(51) Int. Cl. H01M 8/04746; H01M 8/04007; H01M 8/04029; H01M 8/0432; H01M 8/0438

(52) U.S. Cl. CPC H01M 8/04776; H01M 8/04029; H01M 8/04067; H01M 8/04373; H01M 8/04417

(57) ABSTRACT

A cooling system includes: a first pump that is provided downstream of a radiator and upstream of an FC stack in a cooling flow path; an adjustment valve regulates a first flow rate of the cooling water flowing from the radiator to the first pump and a second flow rate of the cooling water flowing from a first branch flow path to the first pump; and a second pump that is provided in a second branch flow path, a controller that determines a first transfer amount of the first pump on the basis of the adjustment degree of the adjustment valve and the temperature of the FC stack, and determines a second transfer amount of the second pump on the basis of the adjustment degree and the first transfer amount.

### CROSS-REFERENCE TO RELATED APPLICATIONS

The present application claims priority to Japanese Patent Application number 2024-014102, filed on Feb. 1, 2024, contents of which are incorporated herein by reference in its entirety.

### BACKGROUND OF THE INVENTION

The present disclosure relates to a cooling system. A conventional cooling system adjusts a first flow rate of cooling water flowing through a first flow path provided for cooling a fuel cell stack on the basis of a second flow rate of cooling water flowing through a second flow path provided for cooling a braking resistor (e.g., Japanese Unexamined Patent Application Publication No 2023-12332).

In the conventional cooling system, the cooling flow path branches into the first flow path and the second flow path at a branch point on the downstream side of a radiator, merges at a merging point on the downstream side of a pump provided in each of the first flow path and the second flow path, and returns to the radiator downstream of the merging point, whereby cooling water circulates. However, when the second flow rate of cooling water flowing through the second flow path is higher than the first flow rate of cooling water flowing through the first flow path, the cooling water flowing through the second flow path may flow back into the first flow path, and thus the fuel cell stack might fail to be appropriately cooled.

### BRIEF SUMMARY OF THE INVENTION

The present disclosure has been made in view of these points, and its object is to appropriately cool a fuel cell stack.

A cooling system according to an aspect of the present disclosure includes: a cooling flow path that circulates cooling water between a radiator and a fuel cell stack; a first pump that is provided downstream of the radiator and upstream of the fuel cell stack in the cooling flow path and transfers the cooling water; a first branch flow path that branches from downstream of the fuel cell stack in the cooling flow path, bypasses the radiator, and merges with the cooling flow path at a first merging point upstream of the first pump; an adjustment valve that is provided at the first merging point in the cooling flow path and regulates a first flow rate of the cooling water flowing from the radiator to the first pump and a second flow rate of the cooling water flowing from the first branch flow path to the first pump; a second branch flow path that branches from a branch point upstream of the adjustment valve in the cooling flow path and merges with the cooling flow path at a second merging point downstream of the fuel cell stack; a braking resistor provided in the second branch flow path; a second pump that is provided upstream of the braking resistor in the second branch flow path and transfers the cooling water; and a controller that determines a first transfer amount of the first pump on the basis of (i) an adjustment degree of the first flow rate and the second flow rate of the adjustment valve and (ii) the temperature of the fuel cell stack, and determines a second transfer amount of the second pump on the basis of the adjustment degree and the first transfer amount.

### BRIEF DESCRIPTION OF THE DRAWINGS

FIG. 1 is a diagram schematically illustrating a configuration of a cooling system S according to the present embodiment.

FIG. 2 is a diagram schematically showing a configuration of the cooling system S provided with a check valve.

FIG. 3 is a diagram schematically showing a configuration of the cooling system S provided with a three-way valve.

FIG. 4 is a diagram illustrating an example of a processing sequence in a controller 30.

FIG. 5 is a diagram illustrating an example of a transfer amount map stored in a storage.

### DETAILED DESCRIPTION OF THE INVENTION

Hereinafter, the disclosure will be described through embodiments of the disclosure. The below embodiments, however, are not intended to limit the disclosure according to the claims, and all combinations of features described in the embodiments are not necessarily essential to the solutions of the disclosure.

### <Configuration of a Cooling System S>

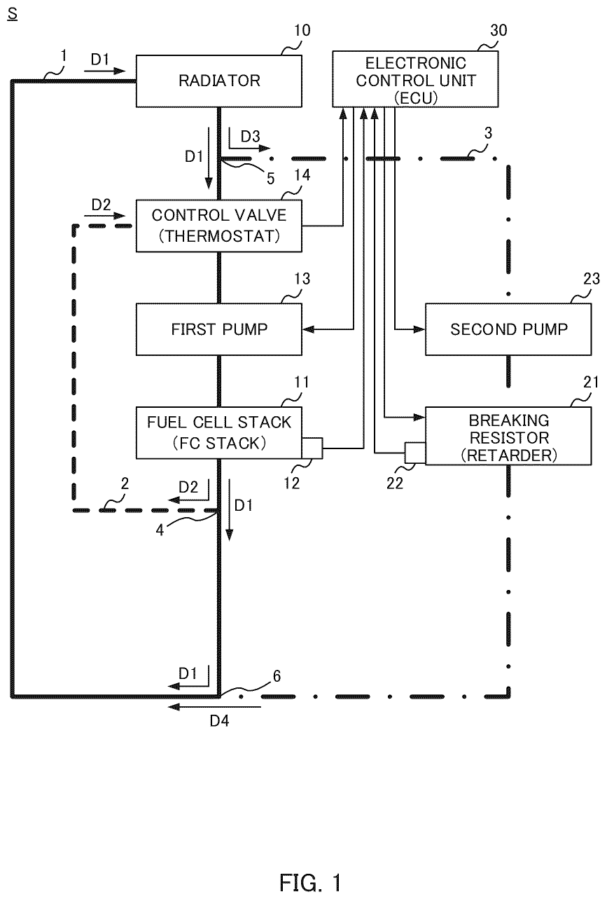

FIG. 1 is a diagram schematically illustrating a configuration of a cooling system S according to the present embodiment. The cooling system S illustrated in FIG. 1 includes a cooling flow path 1, a first branch flow path 2, a second branch flow path 3, a radiator 10, a fuel cell stack 11, a first temperature sensor 12, a first pump 13, an adjustment valve 14, a braking resistor 21, a second temperature sensor 22, a second pump 23, and a controller 30.

The cooling system S is mounted on a vehicle and functions to cool the fuel cell stack 11 and the braking resistor 21 by facilitating heat exchange between the fuel cell stack 11 and the braking resistor 21, and cooling water. First, each flow path through which cooling water flows will be described.

The cooling flow path 1 is a flow path designed to circulate cooling water between the radiator 10 and the fuel cell stack 11, thereby cooling the fuel cell stack 11. In the cooling flow path 1, the radiator 10, the adjustment valve 14, the first pump 13, and the fuel cell stack 11 are provided along a circulation direction D1 of cooling water.

As indicated by a broken line in FIG. 1, the first branch flow path 2 branches from a first branch point 4 on the downstream side of the fuel cell stack 11 in the cooling flow path 1, bypasses the radiator 10, and merges with the cooling flow path 1 at a first merging point (not shown) on the upstream side of the first pump 13. As shown in FIG. 1, the adjustment valve 14 is provided at the first merging point. A direction D2 shown in FIG. 1 is a direction in which the cooling water flows in the first branch flow path 2. Since the first branch flow path 2 is provided in this manner, the cooling system S can cause the cooling water that has not exchanged heat with the radiator 10 to flow to the fuel cell stack 11 when the fuel cell stack 11 does not require cooling.

The second branch flow path 3 is a flow path designed to cool the braking resistor 21. As indicated by a one-dot chain line in FIG. 1, the second branch flow path 3 branches from a second branch point 5 on the upstream side of the adjustment valve 14 in the cooling flow path 1 and merges with the cooling flow path 1 at a second merging point 6 on the downstream side of the fuel cell stack 11. In the second branch flow path 3, the second pump 23 and the braking resistor 21 are provided along a direction D3 in which the cooling water flows. Next, each component provided in each flow path will be described.

The radiator 10 is provided on the upstream side of the adjustment valve 14 in the cooling flow path 1, and cools the cooling water that has passed through at least one of the fuel cell stack 11 or the braking resistor 21. For example, the radiator 10 cools the cooling water by exchanging heat between the cooling water and wind (traveling wind) flowing from the front of the vehicle on which the cooling system S is mounted. The radiator 10 may be provided with a fan that facilitates inflow of wind from the front of the vehicle.

The fuel cell stack 11 is a module in which a plurality of fuel cells are stacked, and is provided downstream of the first pump 13 in the cooling flow path 1. The fuel cell stack 11 generates electricity by, for example, a chemical reaction between (i) a fuel gas such as hydrogen gas and (ii) an oxidant gas such as oxygen in air, and supplies the generated electricity to a drive source (for example, a motor) included in the vehicle equipped with the cooling system S. In the following description, the fuel cell stack 11 is referred to as an FC stack 11.

The first temperature sensor 12 is a sensor for detecting the temperature of the FC stack 11 and outputs the detected temperature to the controller 30. The first pump 13 is provided downstream of the radiator 10 and upstream of the FC stack 11 in the cooling flow path 1 and transfers the cooling water. The first pump 13 includes, for example, a rotor, acquires a first rotation speed corresponding to a first transfer amount from the controller 30, suctions the cooling water by rotating the rotor at the first rotation speed, and discharges the suctioned cooling water to the FC stack 11. The first transfer amount is the amount of cooling water discharged to the FC stack 11 by the first pump 13 per unit time.

The adjustment valve 14 is provided at the first merging point in the cooling flow path 1, and adjusts a first flow rate of cooling water flowing from the radiator 10 to the first pump 13 and a second flow rate of cooling water flowing from the first branch flow path 2 to the first pump 13. The adjustment valve 14 is, for example, a thermostat and includes a first valve for adjusting the first flow rate, a second valve for adjusting the second flow rate, and a thermistor for detecting the temperature of the cooling water at the first merging point. The first valve and the second valve are adjusted so that the opening degree of one of the valves increases as the opening degree of the other valve decreases. The thermistor is provided, for example, at a discharge port of the adjustment valve 14.

The adjustment valve 14 regulates the ratio of the first flow rate to the second flow rate in the flow rate of the cooling water flowing through the first pump 13, for example, by determining the valve opening degrees of the first valve and the second valve on the basis of the temperature detected by the thermistor. Specifically, the higher the temperature of the cooling water at the first merging point, the more the adjustment valve 14 increases the first flow rate and decreases the second flow rate. That is, the higher the temperature detected by the thermistor, the more the adjustment valve 14 increases the valve opening degree of the first valve and decreases the valve opening degree of the second valve. On the other hand, the lower the temperature detected by the thermistor, the more the adjustment valve 14 decreases the valve opening degree of the first valve and increases the valve opening degree of the second valve. The adjustment valve 14 outputs an adjustment degree indicating the determined valve opening degrees of the first valve and the second valve (that is, the ratio of the first flow rate and the second flow rate) to the controller 30.

Since the adjustment valve 14 operates in this manner, the cooling system S can facilitate heat exchange between (i) the cooling water cooled by exchanging heat with the radiator 10 and (ii) the FC stack 11, by increasing the first flow rate as the temperature of the cooling water downstream of the adjustment valve 14 becomes higher. On the other hand, in the cooling system S, by increasing the second flow rate as the temperature of the cooling water downstream of the adjustment valve 14 becomes lower, the cooling water that has not exchanged heat with the radiator 10 can flow to the FC stack 11, and thus it is possible to suppress the FC stack 11 from being supercooled.

Further, in the cooling system S, since the greater the second flow rate (the smaller the first flow rate), the greater a third flow rate of the cooling water flowing from the radiator 10 to the second pump 23 becomes, it is possible to facilitate heat exchange between (i) the cooling water cooled by exchanging heat with the radiator 10 and (ii) the braking resistor 21. Since the greater the third flow rate, the greater the flow rate of the cooling water flowing from the second branch flow path 3 at the second merging point 6 becomes, it is more likely for the cooling water to remain upstream of the second merging point 6 and downstream of the first branch point 4. As a result, at the first branch point 4, the greater the third flow rate, the greater the second flow rate of the cooling water branched into the first branch flow path 2 becomes.

The braking resistor 21 is, for example, a brake such as a retarder, and is provided in the second branch flow path 3. When instruction information indicating a braking command for the vehicle is acquired from the controller 30, the braking resistor 21 brakes the vehicle. The second temperature sensor 22 is a sensor for detecting the temperature of the braking resistor 21 and outputs the detected temperature to the controller 30.

The second pump 23 is provided upstream of the braking resistor 21 in the second branch flow path 3, and transfers the cooling water. The second pump 23 includes, for example, a rotor, acquires a second rotation speed corresponding to a second transfer amount from the controller 30, suctions the cooling water by rotating the rotor at the second rotation speed, and discharges the suctioned cooling water to the braking resistor 21. The second transfer amount is the amount of cooling water discharged to the braking resistor 21 by the second pump 23 per unit time.

The controller 30 is a device including one or more processors such as a central processing unit (CPU) or an electronic control unit (ECU), for example. The controller 30 performs processes including causing the braking resistor 21 to brake the vehicle when receiving a deceleration or stopping operation from a driver of the vehicle, and causing the first pump 13 and the second pump 23 to transfer the cooling water by determining the first transfer amount and the second transfer amount, thereby cooling the FC stack 11 and the braking resistor 21. The controller 30 may include a housing including electronic components, or may be a printed substrate on which the electronic components are mounted.

A conventional controller 30 determines, for example, a first transfer amount corresponding to a subtraction value obtained by subtracting a target temperature of the FC stack 11 from the temperature detected by the first temperature sensor 12, and outputs a first rotation speed of a rotor corresponding to the first transfer amount to the first pump 13. Then, the controller 30 determines a second rotation speed of a rotor corresponding to a second transfer amount on the basis of the first rotation speed of the rotor, and outputs the second rotation speed to the second pump 23.

In the above-described conventional operation, when the adjustment valve 14 decreases a first flow rate and the controller 30 increases the second rotation speed, a flow rate of cooling water flowing from the second branch flow path 3 to the second merging point 6 may become greater than a flow rate of cooling water flowing from the first branch point 4 to the second merging point 6. In this case, if the flow rate of cooling water flowing from the first branch point 4 to the second merging point 6 is extremely low, the cooling water flowing from the second branch flow path 3 to the second merging point 6 may flow back from the second merging point 6 to the first branch point 4, instead of flowing in a direction D4 from the second merging point 6. Therefore, in this embodiment, the controller 30 determines the first transfer amount of the first pump 13 on the basis of (i) the adjustment degree of the first flow rate and the second flow rate of the adjustment valve 14 and (ii) the temperature of the FC stack 11, and determines the second transfer amount of the second pump 23 on the basis of the adjustment degree and the first transfer amount.

For example, the greater the first flow rate corresponding to the adjustment degree acquired from the adjustment valve 14, the more the controller 30 increases the first transfer amount. Further, for example, the higher the temperature of the FC stack 11 detected by the first temperature sensor 12, the more the controller 30 increases the first transfer amount. Next, the controller 30 determines a first relative ratio of the second transfer amount to the first transfer amount on the basis of the adjustment degree, for example, and determines a multiplication value obtained by multiplying the first transfer amount by the first relative ratio as the second transfer amount.

The first relative ratio is a relative ratio for determining the second transfer amount, which is smaller than the first transfer amount, and indicates a value greater than 0 and less than 100 when expressed as a percentage. For example, the greater the valve opening degree of the first valve included in the adjustment degree, the more the controller 30 decreases the first relative ratio.

Then, the controller 30 outputs the first rotational speed corresponding to the determined first transfer amount to the first pump 13, and outputs the second rotational speed corresponding to the determined second transfer amount to the second pump 23. Since the controller 30 operates in this manner, the controller 30 can make the second transfer amount smaller than the first transfer amount, and thus can make the flow rate of the cooling water flowing from the second branch flow path 3 to the second merging point 6 smaller than the flow rate of the cooling water flowing from the first branch point 4 to the second merging point 6. As a result, since the controller 30 can prevent the cooling water from flowing back from the second merging point 6 to the first branch point 4, the cooling system S can appropriately cool the FC stack 11.

In a case where the motor is included in the drive source of the vehicle on which the cooling system S is mounted, when the vehicle accelerates, the FC stack 11 that generates electricity to be supplied to the motor generates heat, but the braking resistor 21 does not generate heat. On the other hand, when the vehicle decelerates or stops, the braking resistor 21 that operates to brake the vehicle generates heat, but the FC stack 11 does not generate heat. That is, when one of the FC stack 11 and the braking resistor 21 is operated and generates heat while the vehicle is traveling, the other does not operate and thus does not generate heat.

Therefore, the controller 30 may determine the first transfer amount and the second transfer amount on the basis of the state of whether or not the braking resistor 21 is operated. For example, when the braking resistor 21 is not in operation, the controller 30 determines the first transfer amount on the basis of the adjustment degree of the adjustment valve 14 and the temperature of the FC stack 11. Then, the controller 30 determines the second transfer amount that is greater than 0 and smaller than the first transfer amount by determining, as the second transfer amount, a multiplication value obtained by multiplying the determined first transfer amount by the first relative ratio corresponding to the adjustment degree, for example.

For example, when the braking resistor 21 is not in operation, after determining the first transfer amount on the basis of the adjustment degree of the adjustment valve 14 and the temperature of the FC stack 11, the controller 30 determines, on the basis of the adjustment degree, a first relative ratio, which is a proportion of the second transfer amount relative to the first transfer amount, for determining the second transfer amount smaller than the first transfer amount, and determines, as the second transfer amount, a multiplication value obtained by multiplying the first transfer amount by the first relative ratio. Since the controller 30 operates in this manner, the cooling system S can flow the cooling water to the FC stack 11 and flow the cooling water from the second branch flow path 3 to the radiator 10, and thus can appropriately cool the FC stack 11 and cool the cooling water.

For example, when the braking resistor 21 is in operation, after determining the first transfer amount on the basis of the adjustment degree and the temperature of the FC stack 11, the controller 30 determines the second transfer amount on the basis of the determined first transfer amount and adjustment degree, and the temperature of the braking resistor. For example, the greater the second flow rate corresponding to the adjustment degree, the more the controller 30 increases the second transfer amount, and the higher the temperature of the braking resistor 21, the more the controller 30 increases the second transfer amount.

For example, when the braking resistor 21 is in operation, the controller 30 determines a second relative ratio of the second transfer amount to the first transfer amount on the basis of the adjustment degree, and determines, as the second transfer amount, a multiplication value obtained by multiplying the first transfer amount by the second relative ratio. The second relative ratio is a relative ratio for determining the second transfer amount which is greater than the first transfer amount, and indicates a value of 100 or more when expressed by a fraction. For example, the greater the valve opening degree of the second valve included in the adjustment degree, the more the controller 30 increases the second relative ratio, and the higher the temperature of the braking resistor 21 detected by the second temperature sensor 22, the more the controller 30 increases the second relative ratio.

When the controller 30 operates as described above, the controller 30 can make the second transfer amount larger than the first transfer amount when the braking resistor 21 is in operation. As a result, the cooling system S can appropriately cool the FC stack 11 that is not generating power without being supercooled, and can appropriately cool the braking resistor 21 that is in an operating state.

Even if the cooling system S can cool the FC stack 11 and the braking resistor 21 by the operation of the controller 30 as described above, the second transfer amount may be larger than the first transfer amount. For example, since the FC stack 11 does not generate power when the braking resistor 21 is in operation, the temperature of the FC stack 11 may decrease and the temperature of the braking resistor 21 may increase, so that the second transfer amount may be larger than the first transfer amount. As a result, in the cooling system S, the cooling water may flow back from the second merging point 6 to the first branch point 4. In contrast, in the cooling system S, a check valve may be provided to prevent backflow.

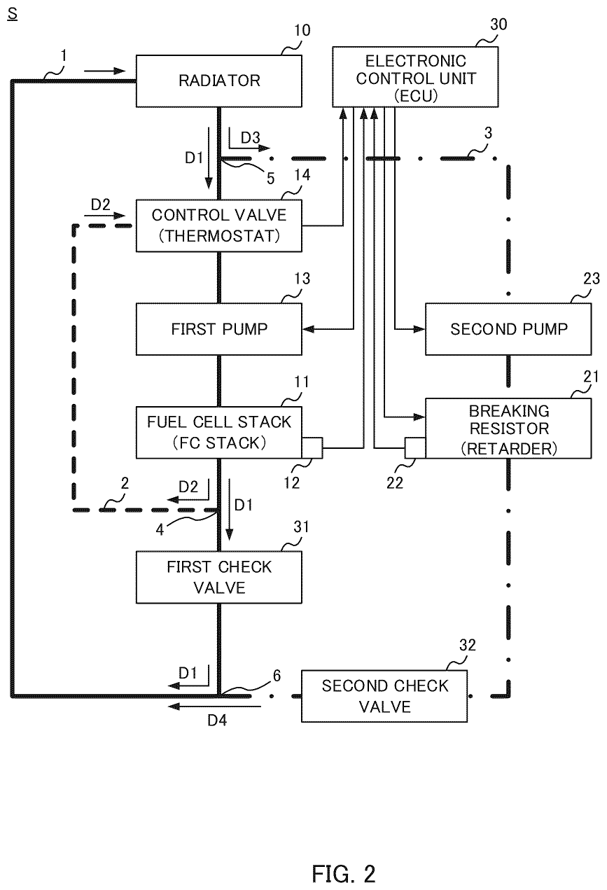

FIG. 2 is a diagram schematically showing a configuration of a cooling system S provided with a check valve. The cooling system S shown in FIG. 2 differs from the cooling system S shown in FIG. 1 in that it includes a first check valve 31 and a second check valve 32, and is otherwise the same. As shown in FIG. 2, the first check valve 31 is provided downstream of the first branch point 4 between the cooling flow path 1 and the first branch flow path 2 in the cooling flow path 1 and upstream of the second merging point 6 in the cooling flow path 1.

By providing the first check valve 31 in this manner, the cooling system S can prevent the cooling water from flowing back from the second merging point 6 to the first branch point 4 even when the second transfer amount is larger than the first transfer amount. Further, in the cooling system S, since the cooling water appropriately flows to the radiator 10 by preventing the backflow, the FC stack 11 and the braking resistor 21 can be appropriately cooled.

Further, as shown in FIG. 2, the cooling system S may include a second check valve 32 on the downstream side of the braking resistor 21 in the second branch flow path 3 and upstream side of the second merging point 6 in the second branch flow path 3. By providing the second check valve 32 in this manner, the cooling system S can prevent the cooling water that has passed through the first check valve 31 from flowing back to the second branch flow path 3 when the second transfer amount is extremely smaller than the first transfer amount.

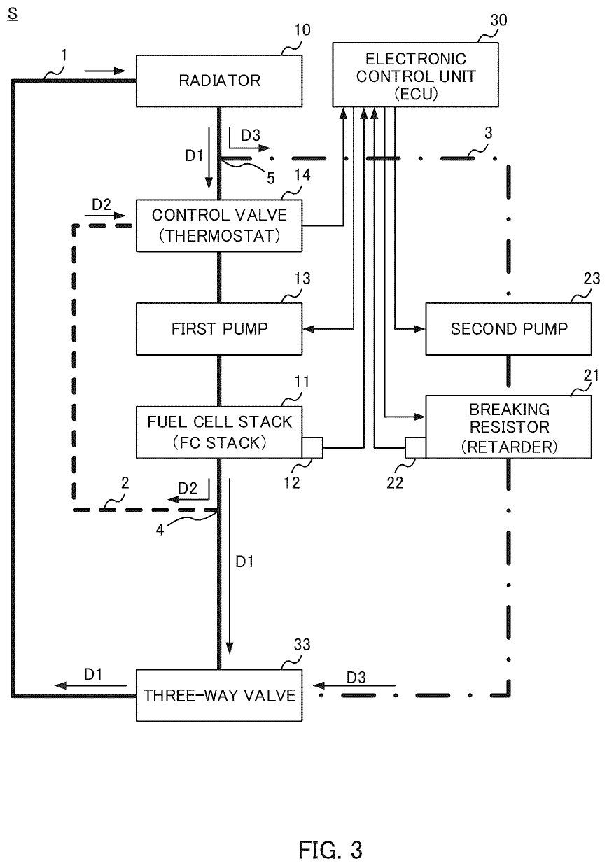

The cooling system S may include a three-way valve instead of the first check valve 31 and the second check valve 32. FIG. 3 is a diagram schematically showing a configuration of a cooling system S provided with a three-way valve. The cooling system S illustrated in FIG. 3 is different from the cooling system S illustrated in FIG. 1 in that a three-way valve 33 is provided, and is the same in other respects. The three-way valve 33 is provided at the second merging point 6, and prevents the cooling water from flowing back between the cooling flow path 1 and the second branch flow path 3. Specifically, the three-way valve 33 allows the cooling water flowing from the first branch point 4 and the braking resistor 21 to the three-way valve 33 to flow downstream of the three-way valve 33 in the cooling flow path 1, thereby preventing the cooling water from flowing (backflowing) from the three-way valve 33 to the first branch point 4 and the braking resistor 21.

### <Processing Sequence of the Controller 30>

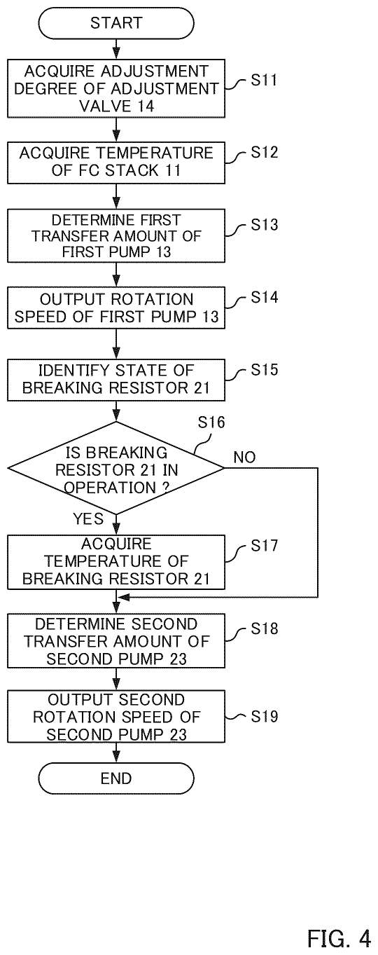

FIG. 4 is a diagram illustrating an example of a processing sequence in the controller 30. The processing sequence shown in FIG. 4 is a sequence showing an operation in which the controller 30 outputs the rotational speed of the rotor to the first pump 13 and the second pump 23. The controller 30 repeats the processing sequence shown in FIG. 4 at a predetermined control cycle (e.g., one second).

The controller 30 acquires the adjustment degree of the adjustment valve 14 from the adjustment valve 14 (S11), and acquires the temperature of the FC stack 11 from the first temperature sensor 12 (S12). The controller 30 determines the first transfer amount of the first pump 13 on the basis of the adjustment degree and the temperature of the FC stack 11 (S13), and outputs the first rotational speed of the rotor corresponding to the first transfer amount to the first pump 13 (S14).

The controller 30 identifies the state of the braking resistor 21 indicating whether or not the braking resistor 21 is in an operating state on the basis of, for example, whether or not the operation of decelerating or stopping the vehicle is received from the driver of the vehicle (S15). When the braking resistor 21 is in the operating state (YES in S16), the controller 30 acquires the temperature of the braking resistor 21 from the second temperature sensor 22 (S17), and determines the second transfer amount of the second pump 23 on the basis of the temperature, the first transfer amount, and the adjustment degree (S18).

On the other hand, when the braking resistor 21 is not in operation (NO in S16), the controller 30 determines the second transfer amount of the second pump 23 on the basis of the first transfer amount and the adjustment degree (S18). The controller 30 outputs the second rotational speed of the rotor corresponding to the determined second transfer amount to the second pump 23 (S19).

### Modification Example

In the above description, an operation has been illustrated in which the controller 30 determines the first transfer amount and the second transfer amount based on parameters, such as the adjustment degree, the temperature of the FC stack 11, and the state of the braking resistor 21, each time they are acquired in a predetermined control cycle. However this is merely an example.

The controller 30 may determine the first transfer amount and the second transfer amount by referring to the transfer amount map stored in the storage of the controller 30. The transfer amount map indicates the adjustment degree, the state of whether or not the braking resistor 21 is operated, the first transfer amount corresponding to the temperature of the FC stack 11, and the second transfer amount corresponding to the first transfer amount.

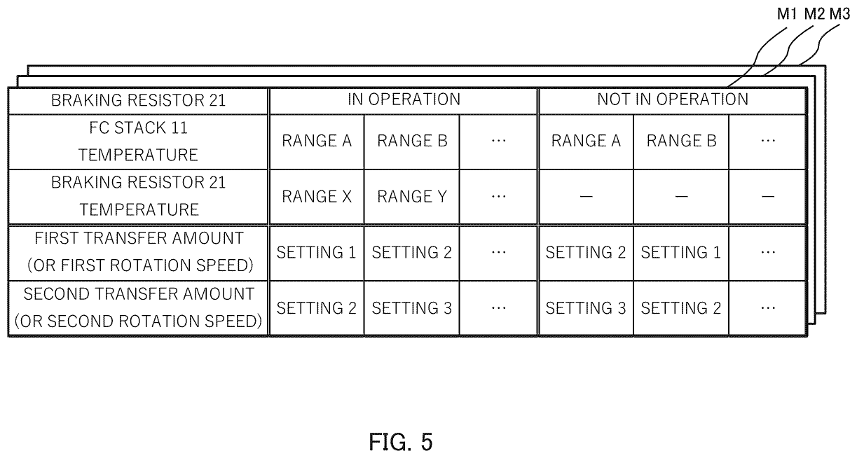

FIG. 5 is a diagram showing an example of a transfer amount map stored in a storage; In FIG. 5, to simplify the description, transfer amount maps M1, M2, and M3 are shown, representing selection among a plurality of transfer amount maps M for each adjustment degree of the adjustment valve 14. Each transfer amount map M shows the “first transfer amount (or first rotation speed)” and “second transfer amount (or second rotation speed)” in relation to the “braking resistor 21”, “FC stack 11 temperature”, and “braking resistor 21 temperature”.

The “braking resistor 21” indicates a state of whether or not the braking resistor 21 is operating. The “FC stack 11 temperature” indicates a range including the temperature detected by the first temperature sensor 12. The “braking resistor 21 temperature” indicates a range including the temperature detected by the second temperature sensor 22. The “first transfer amount (or first rotation speed)” is a setting value for setting the first rotation speed in the first pump 13 corresponding to the first transfer amount or the first rotation speed. The “second transfer amount (or second rotation speed)” is a setting value for setting the second rotation speed in the second pump 23 corresponding to the second transfer amount or the second rotation speed.

The controller 30 identifies the transfer amount map M that corresponds to the adjustment degree acquired from the adjustment valve 14 among the plurality of transfer amount maps M, for example. When the braking resistor 21 is operating, the controller 30 identifies a first range in which the temperature detected by the first temperature sensor 12 is included and a second range in which the temperature detected by the second temperature sensor 22 is included, for example. The controller 30 determines the first transfer amount and the second transfer amount by identifying the setting value to be set to the first pump 13 corresponding to the identified first range and the setting value to be set to the second pump 23 corresponding to the identified second range.

On the other hand, for example, when the braking resistor 21 is not operating, the controller 30 determines the first transfer amount and the second transfer amount by identifying the first range in which the temperature detected by the first temperature sensor 12 is included and by identifying a setting value to be set to the first pump 13 and a setting value to be set to the second pump 23 corresponding to the first range. Since the controller 30 operates in this manner, the controller 30 can reduce the processing load required to determine the first transfer amount and the second transfer amount.

In FIG. 5, the “first transfer amount (or first rotation speed)” may indicate the first transfer amount or the first rotation speed, and the “second transfer amount (or second rotation speed)” may indicate a relative ratio to the first transfer amount or the first rotation speed. As an example, it is assumed that the “first transfer amount (or first rotation speed)” indicates the first rotation speed, and the “second transfer amount (or second rotation speed)” indicates the relative ratio. In this case, when the braking resistor 21 is not in operation, the controller 30 identifies the first rotation speed and the relative ratio corresponding to the identified first range, and determines a multiplication value obtained by multiplying the first rotation speed by the relative ratio as the second rotation speed. In addition, in a state where the braking resistor 21 is operating, the controller 30 identifies the first rotation speed and the relative ratio corresponding to the identified first range and second range, and determines a multiplication value obtained by multiplying the first rotation speed by the relative ratio as the second rotation speed.

### <Effects of the Cooling System S>

As described above, the cooling system S includes: the first pump 13 that is provided downstream of the radiator 10 and upstream of the FC stack 11 in the cooling flow path 1 and transfers the cooling water; the adjustment valve 14 that is provided at the first merging point in the cooling flow path 1 and regulates the first flow rate of cooling water flowing from the radiator 10 to the first pump 13 and the second flow rate of cooling water flowing from the first branch flow path 2 to the first pump 13; and the second pump 23 that is provided upstream of the braking resistor 21 in the second branch flow path 3 and transfers the cooling water; and the controller 30 that determines the first transfer amount of the first pump 13 on the basis of (i) the adjustment degree of the first flow rate and the second flow rate of the adjustment valve 14 and (ii) the temperature of the FC stack 11, and determines the second transfer amount of the second pump 23 on the basis of the adjustment degree and the first transfer amount.

Since the cooling system S is configured in this manner, the controller 30 can determine the first transfer amount by which the first pump 13 transfers the cooling water to the FC stack 11 on the basis of the first flow rate corresponding to the adjustment degree of the adjustment valve 14, thereby enabling an appropriate first transfer amount according to the adjustment degree to be determined. Furthermore, since the controller 30 can determine the second transfer amount smaller than the first transfer amount on the basis of the adjustment degree and the first transfer amount, it is possible to prevent the cooling water flowing through the second branch flow path 3 from flowing backward at the second merging point 6. As a result, the cooling system S achieves proper cooling of the FC stack 11 since the cooling water flows appropriately through each flow path.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A cooling system comprising:
a cooling flow path that circulates cooling water between a radiator and a fuel cell stack;
a first pump that is provided downstream of the radiator and upstream of the fuel cell stack in the cooling flow path and transfers the cooling water;
a first branch flow path that branches from downstream of the fuel cell stack in the cooling flow path, bypasses the radiator, and merges with the cooling flow path at a first merging point upstream of the first pump;
an adjustment valve that is provided at the first merging point in the cooling flow path and regulates a first flow rate of the cooling water flowing from the radiator to the first pump and a second flow rate of the cooling water flowing from the first branch flow path to the first pump;
a second branch flow path that branches from a branch point upstream of the adjustment valve in the cooling flow path and merges with the cooling flow path at a second merging point downstream of the fuel cell stack;
a braking resistor provided in the second branch flow path;
a second pump that is provided upstream of the braking resistor in the second branch flow path and transfers the cooling water; and
a controller that determines a first transfer amount of the first pump on the basis of (i) an adjustment degree of the first flow rate and the second flow rate of the adjustment valve and (ii) the temperature of the fuel cell stack, and determines a second transfer amount of the second pump on the basis of the adjustment degree and the first transfer amount.

2. The cooling system according to claim 1, further comprising:
a first check valve provided downstream of a branch point between the cooling flow path and the first branch flow path in the cooling flow path and upstream of the second merging point in the cooling flow path.

3. The cooling system according to claim 1, further comprising:
a second check valve provided downstream of the braking resistor in the second branch flow path and upstream of the second merging point in the second branch flow path.

4. The cooling system according to claim 1, further comprising:
a three-way valve that is provided at the second merging point and prevents the cooling water from flowing backward in the cooling flow path and the second branch flow path.

5. The cooling system according to claim 1, wherein
the higher the temperature of the cooling water at the first merging point, the more the adjustment valve increases the first flow rate and decreases the second flow rate.

6. The cooling system according to claim 1, wherein
the greater the first flow rate corresponding to the adjustment degree, the more the controller increases the first transfer amount.

7. The cooling system according to claim 1, wherein
the higher the temperature of the fuel cell stack, the more the controller increases the first transfer amount.

8. The cooling system according to claim 1, wherein
the controller determines the second transfer amount on the basis of the determined first transfer amount, the adjustment degree, and the temperature of the braking resistor.

9. The cooling system according to claim 8, wherein
in a state where the braking resistor is operating, the higher the temperature of the braking resistor, the more the controller increases the second transfer amount.

10. The cooling system according to claim 8, wherein
when the braking resistor is not in operation, the controller determines the second transfer amount to be greater than 0 and smaller than the first transfer amount.

11. The cooling system according to claim 1, wherein
the controller determines the first transfer amount and the second transfer amount by referencing a transfer amount map stored in a storage, the transfer amount map indicating the adjustment degree, a state of whether or not the braking resistor is operated, the first transfer amount corresponding to the temperature of the fuel cell stack, and the second transfer amount corresponding to the first transfer amount.

12. The cooling system according to claim 1, wherein
when the braking resistor is not in operation, after determining the first transfer amount on the basis of the adjustment degree and the temperature of the fuel cell stack, the controller determines, on the basis of the adjustment degree, a first relative ratio, which is a proportion of the second transfer amount relative to the first transfer amount, for determining the second transfer amount smaller than the first transfer amount, and determines, as the second transfer amount, a multiplication value obtained by multiplying the first transfer amount by the first relative ratio.

13. The cooling system according to claim 12, wherein
the adjustment valve has a first valve for adjusting the first flow rate, and
the greater the valve opening degree of the first valve included in the adjustment degree, the more the controller decreases the first relative ratio.

14. The cooling system according to claim 1, wherein
when the braking resistor is in operation, after determining the first transfer amount on the basis of the adjustment degree and the temperature of the fuel cell stack, the controller determines, on the basis of the adjustment degree, a second relative ratio, which is a proportion of the second transfer amount relative to the first transfer amount, for determining the second transfer amount greater than the first transfer amount, and determines, as the second transfer amount, a multiplication value obtained by multiplying the first transfer amount by the second relative ratio.

15. The cooling system according to claim 14, wherein
the adjustment valve has a second valve for adjusting the second flow rate, and
the greater the valve opening degree of the second valve included in the adjustment degree, the more the controller increases the second relative ratio, and the higher the temperature of the braking resistor, the more the controller increases the second relative ratio.
